(19) United States
(12) Patent Application Publication
(10) Pub. No.: US 2014/0087351 A1
(43) Pub. Date: Mar. 27, 2014

(54) COMPUTER-BASED APPROACH TO COLLABORATIVE LEARNING IN THE CLASSROOM

(71) Applicant: John Huppenthal, Chandler, AZ (US)

(72) Inventor: John Huppenthal, Chandler, AZ (US)

(21) Appl. No.: 13/626,775

(22) Filed: Sep. 25, 2012

(51) Int. Cl. G09B 7/00

(52) U.S. Cl. CPC G09B 7/00
USPC 434/350

(57) ABSTRACT

A system for providing educators an approach to peer learning that helps students develop skills in specific content areas and build their self-efficacy: (a) collaborative, (b) reward-based educational techniques, and (c) teacher feedback on skill building effectiveness in the classroom environment. The configurable problem settings, problem generator, leveling milestones, classroom configurations, game play, and reporting analytics are made available through a Web portal to those involved with the subject children for which the programs are intended. Additionally, the portal allows for access to on-line reward based point program, a program comprised of a pool of merchants that partner with the present system program to allow exchange of products or discounts on their respective products for participants in the present system program. Players in the game receive virtual rewards for participation.

### BACKGROUND

1. Field of the Invention

The present invention relates to computer-based methods for playing an educational game. In particular, the present invention relates to providing educators of children a collaborative peer to peer learning method for students to develop curriculum skills as well as encourage and motivate children an in an educational setting.

2. Description of the Prior Art

Approximately one-third of students in American classrooms are not engaged in classroom learning. The U.S. Department of Education recently estimated that upwards of 80% of all 12th grades lack proficiency in mathematics. Engagement and motivation are potentially at the root of this problem which includes a behavioral aspect, as students who are engaged are more likely to pay attention and exert greater effort over time. Engagement is crucial for learning, however it is evident that many students are not engaged and subsequently achieving below their academic potential. Performing a task successfully, witnessing peers' successes, being encouraged, and the student's own emotional reactions to the task are all factors that foster positive self-efficacy within students. A student's self-efficacy can influence how he or she perceives tasks. As students engage in self-determined tasks, their beliefs about their capabilities may increase due to the observational learning and social experience of previous successes. Educational approaches capitalizing on self-determined tasks to foster intrinsic motivation may lead to increased self-efficacy for learning.

In an effort to address this issue manly alternatives to the traditional classroom methodology of utilizing homework and individual only assignments are being introduced into the educational system. Three methods emerging are the (a) collaborative, (b) reward-based educational techniques, and (c) teacher feedback on skill building effectiveness.

1. The Collaborative Approach;

Prior attempts to develop collaborative in-class learning methods for teaching core curriculum skills to children have suffered from a lack of correlation between motivation and self-efficacy. For example, such solutions may provide dissemination of core curriculum content and or problems, but then fail to involve the students in a collaborative environment that stimulates and motivates participation without fear of embarrassment of an individual's score being published to the entire team and allowing all individuals within a team to experiencing success and “leveling up” as the collaborative team completes core curriculum challenges. Additionally, other systems have not created the unique variance of problem or challenge time lengths set by the teacher along with real-time feedback scoring for all teams participating within a given challenge. In other instances, well-developed core curricula systems may not be connected with individual student profiles and the overall team profile for separate and distinct rankings along with analytics that have unique data elements directly linked to the core curriculum. Furthermore, other existing systems do not allow for individual team member to rank each other based on participation in problem challenges in set periods or levels allowing the teacher to interface with these rankings to create the distribution of grades.

2. Reward-Based Educational Techniques;

In reference to the reward-based technique, these systems reward students upon accomplishment in particular educational goals. This reinforcement is meant to motivate the students to work harder at school-related task. One can look for an example at the Barton Elementary School in Chicago, Ill., where teachers reward students with “Barton Bucks” for attending class, and completing necessary assignments and other educational goals. These “Barton Bucks” can then be used in the school store to buy certain items classified to be purchased with “Barton Bucks”. These school dollars can only be used at the school store with items the school has identified to be redeemable by “Barton Bucks”. This issue of reward based school only money is limited and can be expanded to be more convertible reward-based currency that could be redeemed or used at a variety of merchants thus providing the students with a more desirable reward with would potentially provide greater motivation for the student to succeeded in educational milestones.

3. Teacher Feedback on Skill Building Effectiveness;

This procedure may help an individual teacher evaluate particular deficiencies in their teaching skills, the feedback stemming from questions are not organized or rooted in particular deficiencies that can be identified in a particular subject matter, these deficiencies impede students from achieving their fullest potential. Additionally, typical feedback does not identify the specific strengths and weaknesses a teacher possess in a particular subject matter being taught in the classroom environment. Typical feedback methods merely provide subjective or raw evaluations of teaching effectiveness without targeting the specific skills the teacher was trying to build in the classroom environment. Therefore, there is a need for helping teachers realized what skills there are specifically not helping students improve or learn on. Identifying specifically the types of core fundamentals where a teacher in not being effective in the classroom, will directly support that teacher to address these deficiencies in their particular learning environment to better improve their impact on students skill building potential.

### SUMMARY OF THE INVENTION

The present system is a computer-based mathematics game that has been developed from common core learning standards, which are the national grade-by-grade learning goals in education. In 2008, Mr. John Huppenthal, Arizona Superintendent of Public Instruction, teamed with the Applied Learning Technologies Institute at Arizona State University to implement the present system. Design-based research and development practices were integrated for this project. The intent is to create a math and related curriculum game that would draw from best practices in business and education, including games-based educational research as well as educational technology research. The present system capitalizes on specific aspects of a technology-based approach such as immediate feedback and graduated scaling to maintain focused attention. This enhances math and other educational curriculum fluency skills, and in turn has the potential to lead to increased self-efficacy as students become more confident in their curriculum abilities.

In various embodiments, the present invention provides a computer-based system, e.g., a server or other system, which includes a processor and a storage medium communicatively coupled thereto. The storage medium stores computer-executable instructions, which when executed by the processor cause the processor to execute a program module configured with sub-modules for child development in math and other educational disciplines utilized collaborative learning, reward-based incentives; along with providing teachers and administrators valuable analytics for assessing student skill mastery and teacher effectiveness in the classroom environment.

Widespread use of technology and the Internet has opened up new tools for educators to facilitate learning strategies. Today, children spend leisure time on cell phones, iPads, laptops or other electronic devices. It is no longer sufficient to simply place a computer in a classroom; students must actively absorb technology. With this knowledge, the Huppenthal Method, as illustrated through the present system, uses technology as the basis for learning to occur.

In the classroom, elementary school students begin to play the present system by sitting at individual computers. Each student is assigned a username and password and must log in to begin the game. Computers are placed next to each other, and can be set up in small clusters or a large semi-circle. One of the appealing elements of the present system is that it is packaged as a “game.” After students login they will see several male and female avatars that they are able to personalize. Later, they can also choose rewards for their avatars. The game is basketball-themed, thus the main screen shows a basketball court and students answer math problems that appear on the court. Like shooting a free throw in basketball, students understand the importance of practicing fundamental math skills. In addition to creating a more “game-like” feel, the basketball theme represents the important notion of classroom teamwork.

For example, once all students have joined the game, the teacher reminds them that they are working toward a common goal of answering as many math problems correctly and quickly as possible. Consistent with the premise of collaborative learning theory, students are instructed that their individual score will help the team and that their participation is important in order to increase the team score. Although students may be at different levels, for instance one student may be at level sixteen and another student at level eighty-three, the emphasis is placed on team effort as the aim is to add points to the team goal. Students are also encouraged to collaborate by helping peers if they need assistance. They are allowed to ask others for help, after attempting to solve the problem on their own. Thus, high performing students learn that they need to encourage and help low performers, while low performing students learn that the class needs their effort and participation. In this way, positive interdependence is created immediately in the classroom. Students realize that all team members share a common fate, and that the team, not the individual, will each benefit from the collective effort. All students begin the game at the same time, and each math problem that is answered correctly, on the first attempt is added to the team score. The student's avatar will provide the correct answer if a problem is answered incorrectly on the first attempt and the student must enter the correct answer in order to advance to the next problem. In order to move to the next level, students must correctly answer problems within the current level.

An important feature of the present system is that students will not be individually informed when they move up a level, but will simply be given more complex problems. In “leveling up,” the graduated scaling feature of the present system allows the game to be useful for all students, regardless of their skill level. Most importantly, graduated scaling helps students learn at a level that is consistent with their skills, which will increase the students' sense of competence and helps build self-efficacy. While the students play, only the team score and timer are visible at the top of their screen.

Student engagement is maintained not only through interaction with other students, but also by the fact that the each round of the present system lasts for only several minutes before the game stops for everyone. The teacher can set the game to last between 30 seconds and five minutes. Not only is attention focused for a short period of time, the student is fully engaged both by inputting responses and verbally expressing their mathematical thought process by talking with their peers. As the students solve the math problems immediate feedback is given by the avatar.

Upon completion of a session or game, the teacher displays the results to the class, and shows them the level they achieved as well as their class accuracy (all of the problems that were answered correctly on the first attempt). If the class goal that is pre-determined by students and the teacher at the beginning has been met, the computer will then randomly select one-sixth or another predetermined ratio of the class as winners. The random assignment of rewards ensures that all students have an equal chance of being chosen as winner. The present system reward system reinforces collaboration, as students understand that if they do not receive a reward after a particular game, they will have another opportunity soon. Winners receive an avatar reward, which includes virtual clothing, badges, water bottles, and/or accessories for their avatar along with “Bucket Cash” points that can be used for redeeming prizes at the school and or discounts on products from participating merchants. Participating merchants sign up with the present system program in advance though a universal debit card program that the present system is the primary sponsor of. This program allows exchange of “Buck Cash” points to be used as reward points for participating merchants that accept these accrued points as either cash value or earned discount values.

After the distribution of rewards, the students will collectively choose whether they want to play another round, or stop for the day. This choice is central to the game and the Huppenthal Method as it builds upon the principle of self-determination. When students are aware that they want to do something, and they find value in a particular activity they have a stronger sense of self-determination. When students feel forced to do something (“I should” or “I must”) or they believe that someone else is making a choice for them, they feel less intrinsically motivated to participate. In the context of the present system, students' needs for self-determination are fulfilled as they vote on whether to play another game. If the class goal was achieved, they can also vote on a new goal before starting the next round of the present system.

### BRIEF DESCRIPTION OF THE DRAWINGS

The present invention is illustrated by way of example, and not limitation, in the figures of the accompanying drawings in which:

FIG. 1 illustrates an example of a computer network in which embodiments of the present invention may find application and use;

FIG. 2 illustrates an example of a computer system or electronic input device suitable for configuration in accordance with embodiments of the present invention;

FIG. 3 illustrates software architecture of a computer system configured in accordance with an embodiment of the present invention;

FIG. 4 illustrates an overview of a server-based application configured in accordance with an embodiment of the present invention;

FIG. 5 illustrates a sequence process for an administrator or teacher user in accordance with an embodiment of the present invention;

FIG. 6 illustrates a sequence process for student user in accordance with an embodiment of the present invention;

FIG. 7 illustrates an example of a user interface for building problems types in accordance with an embodiment of the present invention;

FIG. 8 illustrates additional aspects of a user interface configuring problem types in accordance with an embodiment of the present invention;

FIG. 9 illustrates still a further aspect of a user interface for configuring problem types in accordance with an embodiment of the present invention;

FIG. 10A illustrates yet another further aspect of a user interface for configuring problem types in accordance with an embodiment of the present invention;

FIG. 10B illustrates a detailed user interface for testing problem types constructed in accordance with an embodiment of the present invention.

FIG. 11 illustrates an example of a user interface for configuring problem levels in accordance with an embodiment of the present invention;

FIG. 12 illustrates an example of an administrator/teacher user interface for updating and viewing class roster in accordance with an embodiment of the present invention;

FIG. 13 illustrates an example of a student user interface for playing the “free throws” game in accordance with an embodiment of the present invention;

FIG. 14 illustrates additional aspects of a student user interface for playing the “free throws” game in accordance with an embodiment of the present invention;

FIG. 15 illustrates summary data aspects of a student user interface for playing the “free throws” game in accordance with an embodiment of the present invention;

FIG. 16 illustrates between game characteristics of a student user interface for playing the “free throws” game in accordance with an embodiment of the present invention;

FIG. 17 illustrates customizable profile characteristics of a student user interface for playing the “free throws” game in accordance with an embodiment of the present invention;

FIG. 18 illustrates a student user interface for individual profile game rewards for playing the “free throws” game in accordance with an embodiment of the present invention;

FIG. 19 illustrates an example of a detailed statistical report prepared in accordance with an embodiment of the present invention;

FIG. 20 illustrates an additional example of a detailed statistical report prepared in accordance with an embodiment of the present invention;

FIG. 21 illustrates still another example of a detailed statistical report prepared in accordance with an embodiment of the present invention;

FIG. 22 illustrates the problem generator architecture in accordance with an embodiment of the present invention;

FIG. 23 illustrates an example of a classroom computer network utilizing the free throws innovation in which embodiments of the present invention may find application and use;

FIG. 24 illustrates an example of database configurations for problem level valuations in accordance with an embodiment of the present invention;

FIG. 25 illustrates an example of database configurations for user point calculations and question and answer storage results required for the leveling process in accordance with an embodiment of the present invention; and

FIG. 26 illustrates an example of level point valuations and corresponding grade indicators in accordance with an embodiment of the present invention; and

FIG. 27 illustrates an example of how “Bucket Cash” points are calculated and stored on the server for each student's profile in accordance with an embodiment of the present invention.

### DETAILED DESCRIPTION

Described herein are computer-based methods and systems for providing educators an approach to peer learning that helps students develop skills in specific content areas and build their self-efficacy: (a) collaborative, (b) reward-based educational techniques, and (c) teacher feedback on skill building effectiveness in the classroom environment. In various embodiments of the invention, the configurable problem settings, problem generator, leveling milestones, classroom configurations, game play, and reporting analytics are made available through a Web portal or other computer-based resource, accessible to educators, students, administrators, parents, and others involved with the subject children for which the programs are intended. Additionally, the portal allows for access to on-line reward based point program, a program comprised of a pool of merchants that partner with the present system program to allow exchange of products or discounts on their respective products for participants in the present system program. Players in the game receive rewards for participation and performance in the form of “Bucket Cash” points that equate to value on each merchants individual exchange rate valuation. The curriculum from which the programs are derived stems from the “Common Core” states standard initiative program comprising of Math and English curriculums, and each program is composed of trainings developed to give the teacher examples of specific models that should be taught. Thus, the present invention provides grade-appropriate, comprehensive learning tools for children to build skills required for their particular grade and above, to potentially advance beyond their current expectations. Based upon the configuration and initialization of predetermined levels (milestones) and problem types; each student utilizing this invention will build a personalized progressing roadmap of their learning capacity as well as facilitating their team (class) accumulative score to move up to higher levels (milestones).

Students can become more engaged through collaboration with peers. When collaborating to achieve a shared goal, students depend on their own experiences, as well as the experiences of others, to solidify their learning; this forms the basis of cooperative learning. Conferring to cooperative learning theory, student goals are linked together, known as “interdependence”. Interdependence can be classified as either positive or negative. Negative interdependent learning situations allow for some students to succeed while others fail. For instance, a classroom system where only one student is deemed “winner,” signifies negative interdependence. We as implementing a class or team scoring based system with focus placed on team feedback and not individual assessment is show to promote greater learning capacity for all participants in contract to simply focus on just the individual.

In contrast, positive interdependent learning contexts allow for the success of all students, as the entire group is rewarded. No single winner is chosen. Studies have documented the advantages of positive interdependence, as those who work collaboratively display more positive attitudes toward the learning material and toward school. They also have the opportunity to develop positive relationships with fellow students, which contributes to greater confidence and social skills which furthers the learning experience.

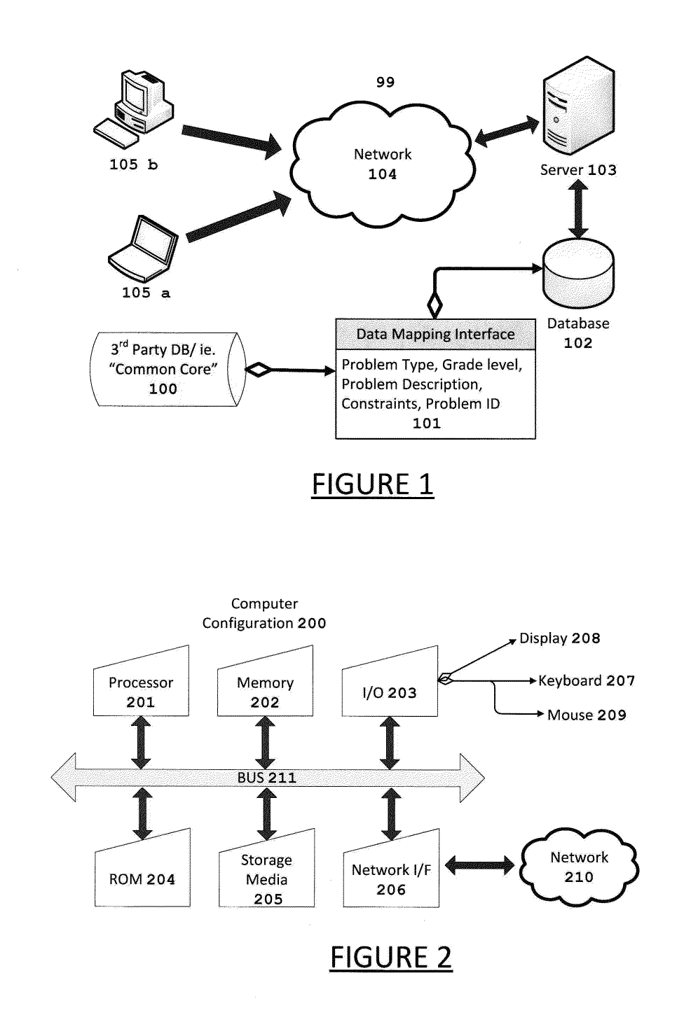

Before describing aspects of the present invention in detail, it is helpful to first discuss the environment in which embodiments of the invention operate. FIG. 1 is a simplified illustration of a computer server 99 which is such an environment. A key optional component to this network 99 is the ability to sync up to a 3^{rd} party database equivalent to the “Common Core” 100 via a data mapping interface for collecting standards and metadata desired by the present system database 102. Such data would be translated into typical database tables and fields through the data mapping 101 utility program. Network 99 includes one or more client computer systems 105a-105b, which may be used by educators and others seeking to access a server 103 at which an instantiation of a computer-based application which provides the features discussed above may be installed and accessible. Server 100 is a 3^{rd} party provider of data standards that are mapped into a database 102 via a mapping interface 101 to inject properly formatted data into the 102 database. Potentially, server 100 would house the “Common Core” data library for specific standards in math and English that database 102 would utilized to create problem type settings for game configurations. Such access may be a computer network or network of networks 104, such as a local and/or wide area network. In some cases, network 104 may be or include the network of networks commonly known as the Internet. In other instances, network 104 may be a local area network (LAN) of an enterprise and/or a virtual LAN which is instantiated over the Internet or other networks of networks. Server 103 is communicatively coupled to a database 102, which may store records pertaining to student's current leveling, question and answer performance, and rewards earned data, along with other information as described further below. Client computers 105a-105b may be any form of computer-bases system, including personal computers, laptop computers, net book computers, mobile devices, smart phones, and the like. Generally, a client computer 105 will run a Web browser application, through which the application running on server 103 may be accessed, however, in some instances, client computers 105 may run a client application specially configured to interface with the application running on server 103.

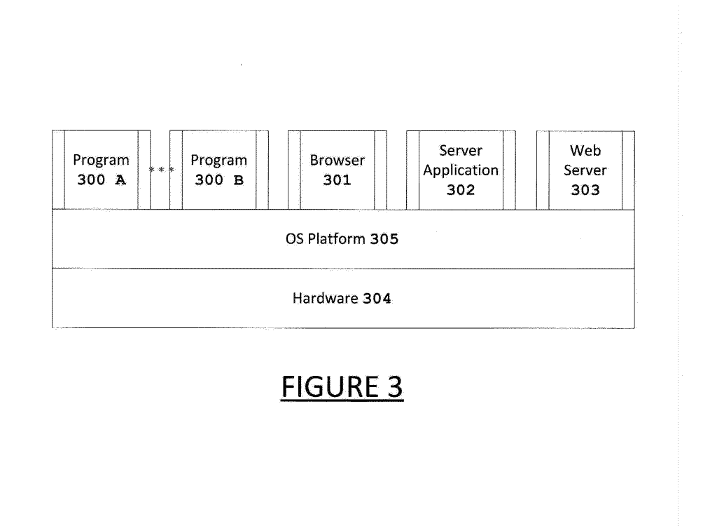

FIG. 2 is a block diagram illustrating an example of a computer system 200. Any of client computer systems 105a-105b and/or server 103 may be configured in the manner described for computer system 200.

Computer system 200 includes a bus 211 or other communication mechanism for communicating information, and a processor 201 coupled with the bus 211 for processing information. Computer system 200 also includes a main memory 202, such as a random access memory (RAM) or other dynamic storage device, coupled to the bus 211 for storing information and instructions to be executed by processor 201. Main memory 202 also may be used for storing temporary variables or other intermediate information during execution of instructions to be executed by processor 201. Computer system 200 further includes a read only memory (ROM) 204 or other static storage device coupled to the bus 211 for storing static information and instructions for the processor 201. A computer-readable storage device 205, such as a magnetic disk or optical disk, is provided and coupled to the bus 211 for storing information and instructions.

Computer system 200 may be coupled via the bus 211, either directly or via an input/output module 203, to a display 208, such as a flat panel display, for displaying information to a computer user. An input device 207, including alphanumeric and other keys, is coupled to the bus 211 for communicating information and command selections to the processor 201. Another type of user input device is cursor controller 209, such as a mouse, a trackball, or cursor direction keys for communicating direction information and command selections to processor 201 and for controlling cursor movement on the display 208.

As should be apparent, aspects of the present invention involve computer software running on server 103. That software may take the form of computer-executable instructions stored in main memory 202 and/or storage device 205, to be executed by processor 201. In other instances, the instructions may be stored on other computer-readable media, such as a floppy disk, a flexible disk, a hard disk, magnetic tape, or any other magnetic medium, a CD-ROM or DVD-ROM, flash memory, or any other physical medium adapted to store computer-readable instruction and from which a computer processor can read. Execution of the sequences of instructions contained in the main memory 202 causes the processor 201 to perform the processes described herein to provide mathematical or English based problems, answers, analytics, and/or game play rewards. In alternative embodiments, hard-wired circuitry may be used in place of or in combination with computer software instructions to implement the invention. Thus, embodiments of the invention are not limited to any specific combination of hardware circuitry and software.

The algorithms and processes presented herein may be implemented in hard-wired circuitry, by specially programming a general-purpose computer system or by any combination of hardware and software. One of ordinary skill in the art will immediately appreciate that the invention can be practiced with computer system configurations other than those described above, including hand-held devices, multiprocessor systems, microprocessor-based or programmable consumer electronics, digital signal processor-based devices, personal computers, minicomputers, mainframe computers, etc. The invention can also be practiced in distributed computing environments where tasks are performed by remote processing devices that are linked through a communications network. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computer system 200 also includes a network interface 220 coupled to the bus 202. Network interface 206 provides a two-way data communication path for computer system 200 to/from a network 210. For example, network interface 206 may be an integrated services digital network (ISDN) card or a modem to provide a data communication connection to a corresponding type of telephone line. As another example, communication interface 206 may be a LAN card to provide a data communication connection to a compatible LAN. Wireless communication links may also be implemented. In any such implementation, network interface 206 sends and receives electrical, electromagnetic or optical signals which carry digital data streams representing various types of information. In one embodiment, network 206 may be network 104, or may be communicatively coupled thereto.

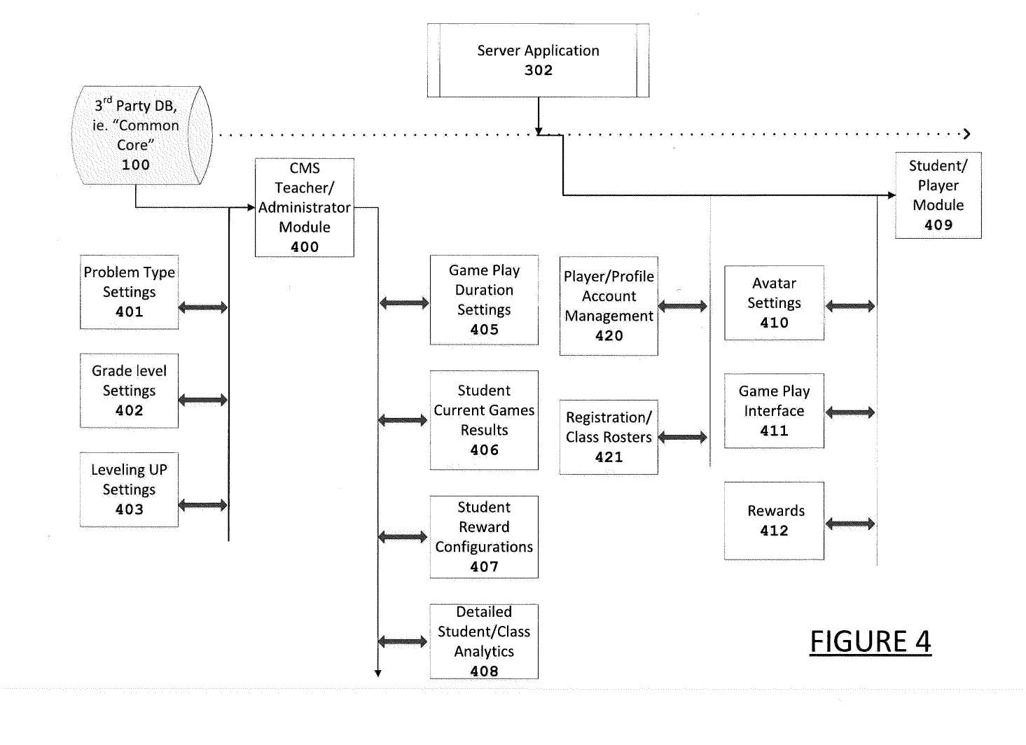

FIG. 3 shows an architecture view of computer system 200. The various hardware components of computer system 200 are represented as a hardware layer 304. An operating system 305 abstracts the hardware layer and acts as a host for various applications 300a-300b, that run on computer system 200. In the case of a client computer system, the operating system also acts as a host for a Web browser application 301, while in the case of the server 103, the operating system acts as a host for a server application 302 configured to perform the processes described herein to provide training materials, on-line assessment tools, and/or individualized curricula responsive to requests and other information received from a client computer system. For the server 103, the operating system may also host a web server application 303, which provides access from the client computers via web browsers. In other instances, the web server may be hosted on a separate server (not shown in detail), which is communicatively coupled to a server hosting application 302.

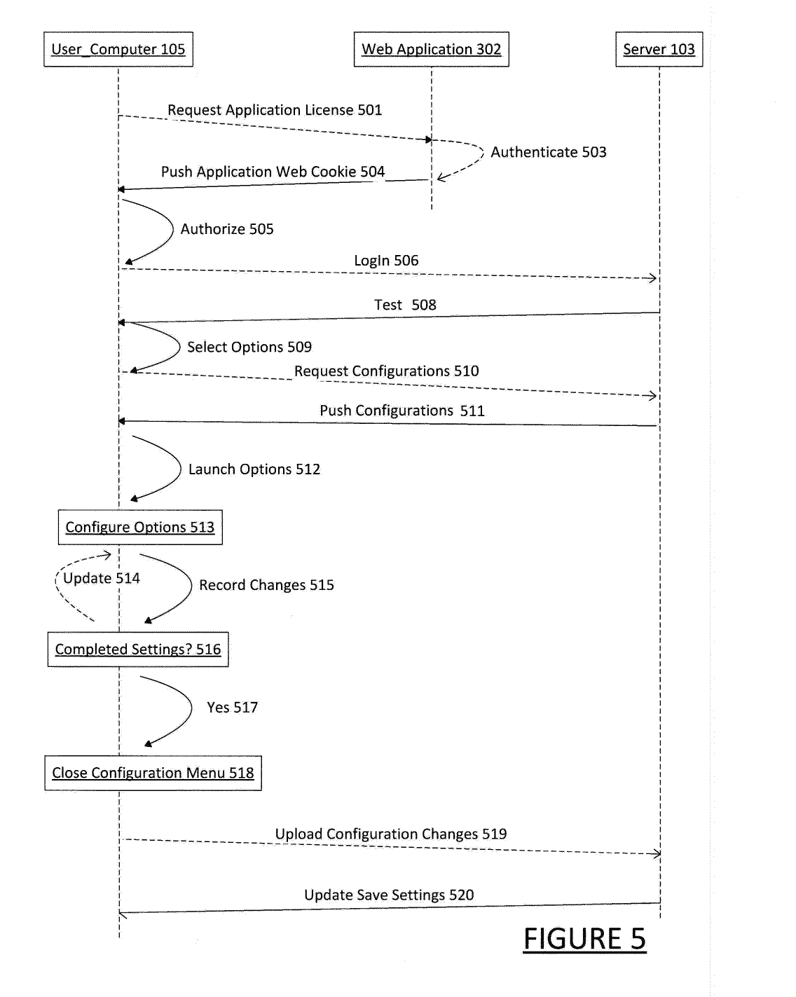

FIG. 4 provides an overview of the server-based application known as “The present system” 302 in greater detail. The application includes a CMS (Content Management System) module 400, and a student/player account management module 409; the “Common Core” 100 interfacing curriculum, and a registration module 420.

The registration module 420 allows teachers, administrators, and student users to set up accounts with the system, maintain user names, passwords and other information needed to access the services provided by the present system, and to establish records for various students under the tutelage or care of the user. The precise details of the registration module are not critical to the present invention. Of course, other modules may also be included but are not described herein in detail so as not to distract from the salient features of the present invention. Further, in some instances, the CMS module 400 may not be included or may be a separate application from server application 302.

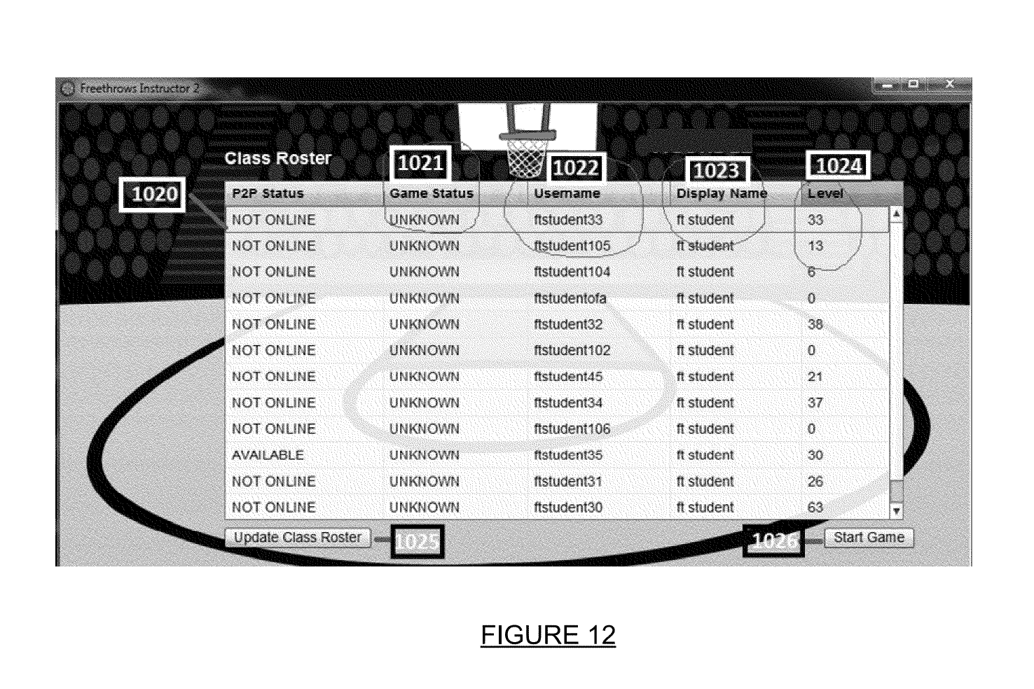

Account management module 420 includes a registration/class roster module 421. The registration module 421 allows users to set up accounts with the system, maintain user names, passwords and other information needed to access the services provided by the present system, and to establish records for various children and classroom associations under the tutelage or care of the user based on user type and permissions granted. Teachers and administrators can update rosters here 1025 and initiate new games 1026 to be started. FIG. 12 illustrates the base data entered on each student including Username 1022 that the student is assigned by administrator or teacher, Display Name 1023 that is displayed throughout the game interface 411 to identify the student, Level 1024 that the specific student is currently at, and Status 1020 of the availability of the student to engage in the game interface 411. The precise details of the registration module are not critical to the present invention.

The student/player account management module 409 includes three sub modules including: an Avatar settings module 410, the main game play interface module 411, and the rewards module 412.

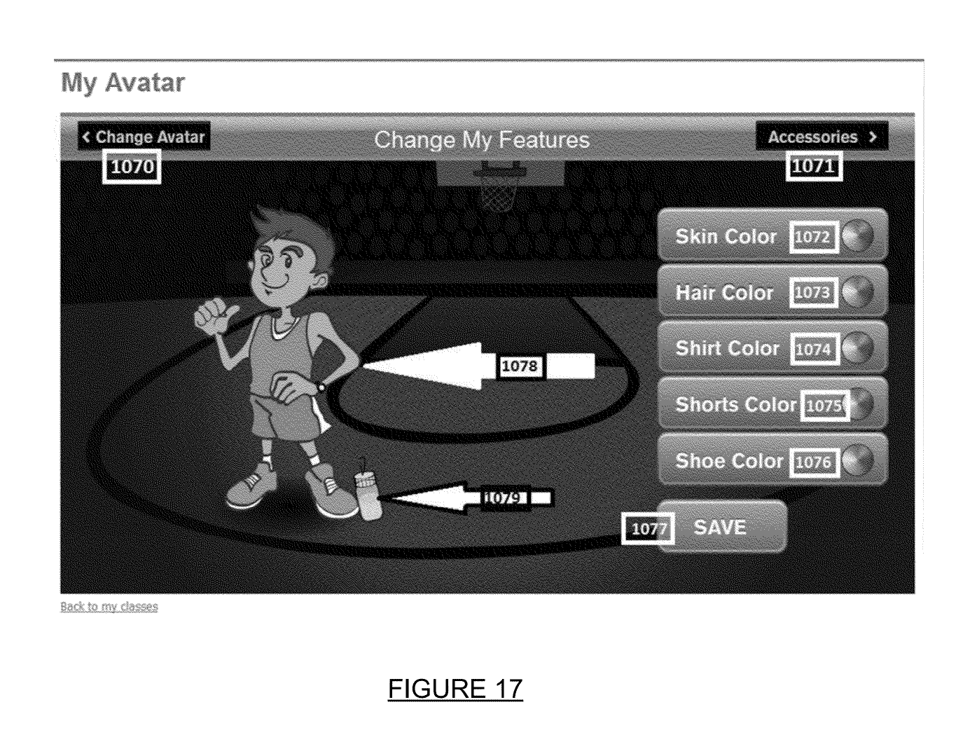

Module 410 houses the avatar settings that provide the game user access to their particular customizable profile avatar that represents the individual student throughout the present system game. This module controls a variety of setting (FIG. 17) that the user can adjust their personalized avatar 1078 to fit the students unique personality including Skin Color 1072 of the Avatar, Hair Color 1073 of the Avatar, Shirt Color 1074 of the Avatar, Shorts Color 1075 of the Avatar, Shoe Color 1076 of the Avatar, Change out base Avatar 1070 for a new one, Add or change accessories 1079 when available

Once desired changes have been adjusted the student simple clicks the save button 1077 to update their avatar. Additionally, when rewards are won or granted to the student in the form of additional avatar features 1079 in the form of customizable objects like water bottles and clothing accessories, they can be accessed and configure via this module.

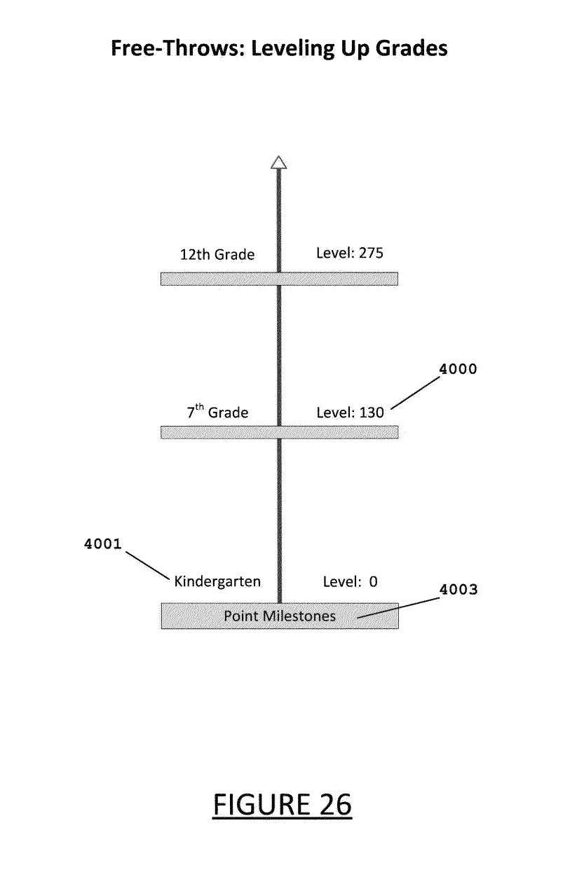

Module 411 is the main game interface where users play the present system game in a peer to peer environment allowing multiple players simultaneously compete together to achieve milestones, while at the same time also building a personal performance profile that is hidden and only available to the teacher and administrators; only team and or class performance milestones are displayed. These milestones are in the form of levels that correspond to specific grade comprehension in math or a given curriculum. In FIG. 26 illustrates this relationship between point levels 4000 and specific grade comprehension 4001. The total point a class, team, or an individual has accumulated at any given time is the milestone 4003 they have achieved.

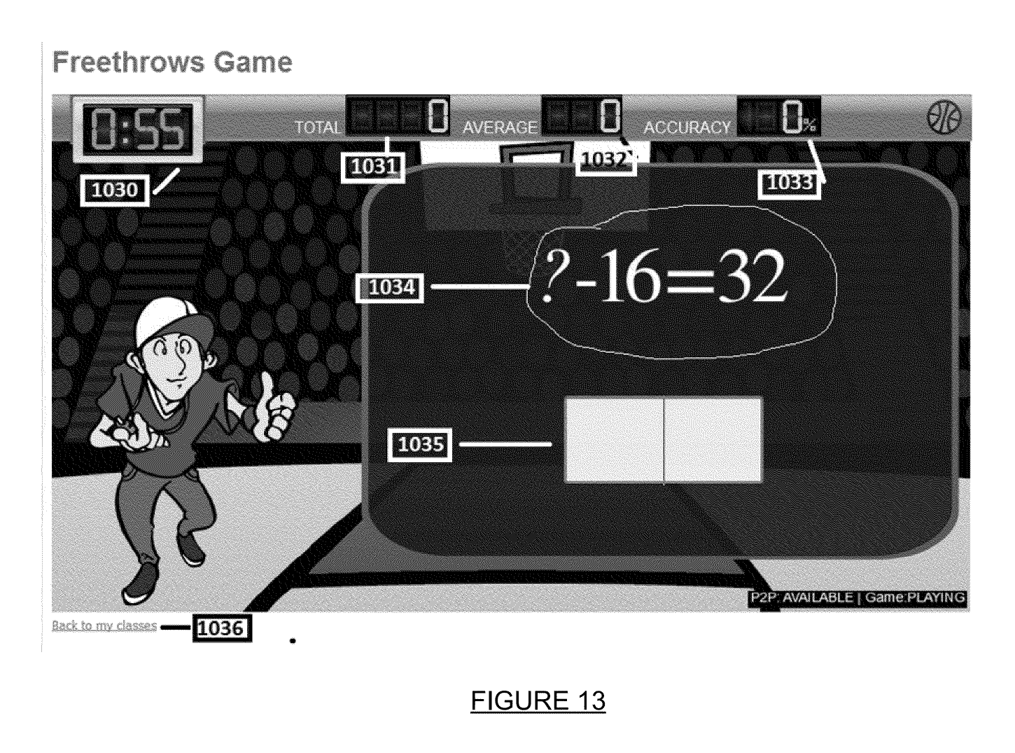

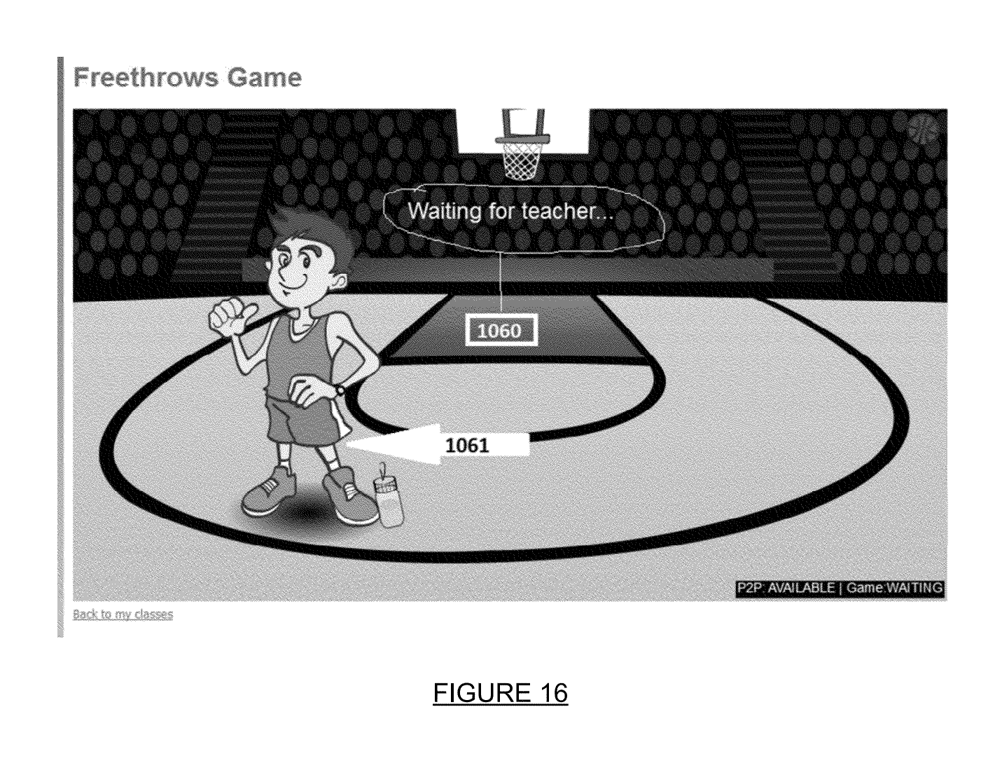

Game play is based around a basketball theme where the problem is depicted on the court for the student to solve. The home screen for a student (FIG. 16) will display the student's personalized avatar 1061 while informing the student when the game will start 1060. FIG. 13 illustrates the main game interface including such elements:
1. Total 1031 Questions answered for the class or team—NOT individual performance, the overall approach to the present system concept is to not focus on individual student performance but rather the class or team as a whole, In this main interface both the teachers and students ONLY see team statistics.
2. Average 1032 Questions answered per student player
3. Accuracy 1033 of correctly answered questions by the class or team
4. The current problem presented 1034
5. The space for a student player to enter their answer 1035
6. The amount of time left 1030 in a given game
7. The ability for a student to leave a game in progress 1036

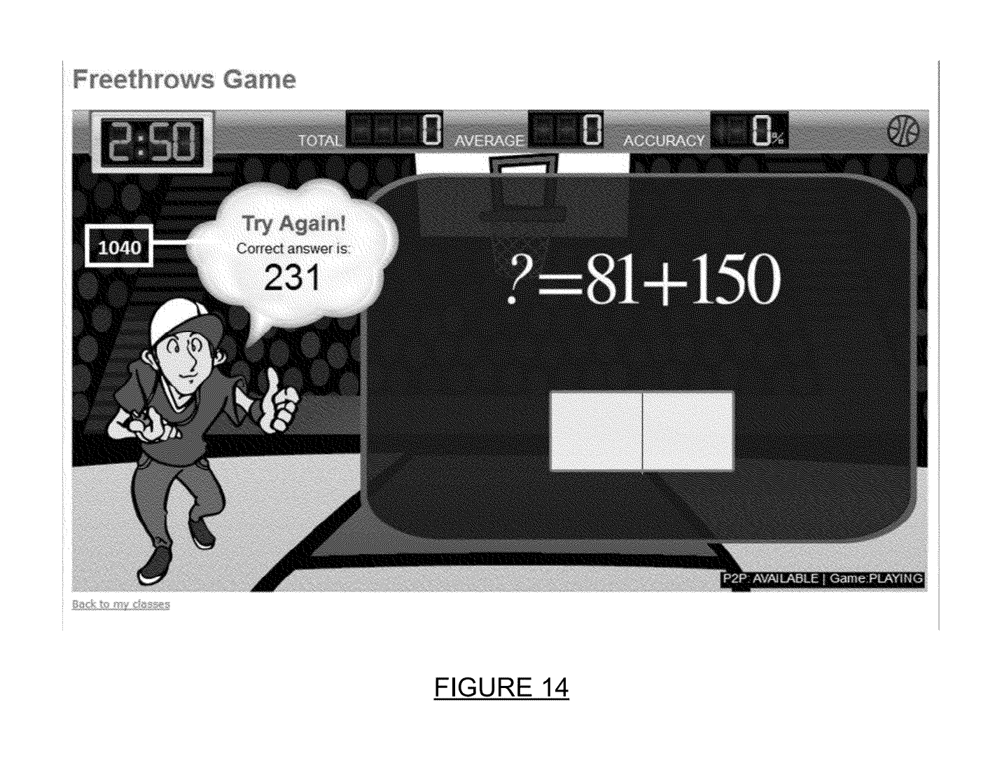

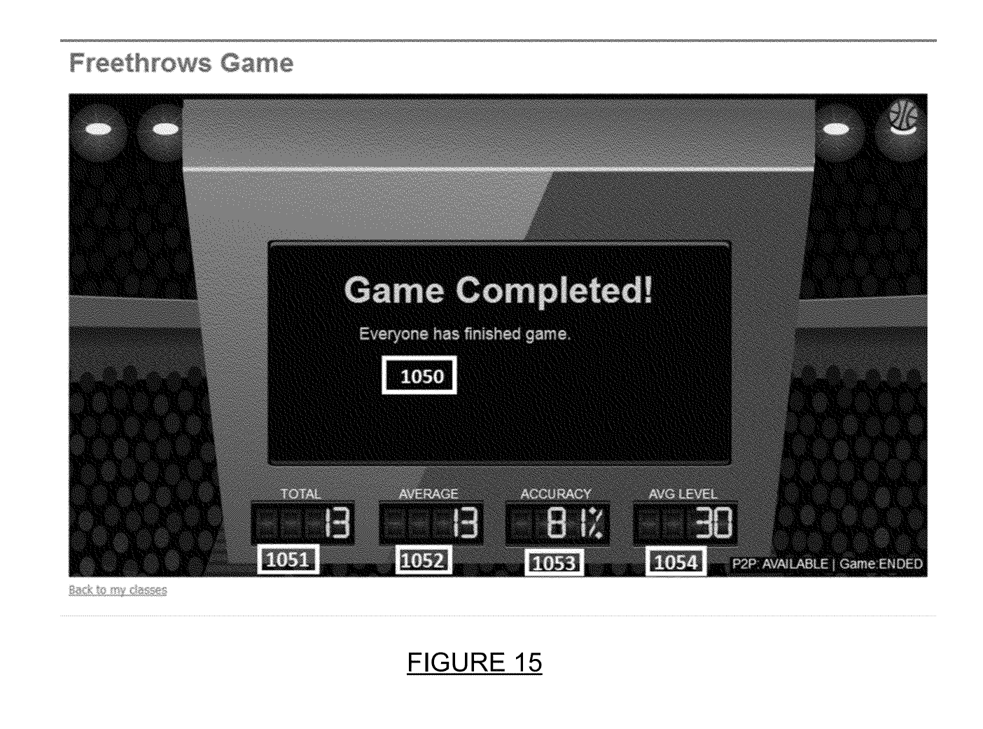

Each game has a time limit that is predetermined by the teacher, typically from 30 seconds to 5 minutes. Each student can answer correctly as many questions as they can during this time period. Incorrect questions on the first attempt will generate quick feed-back to the student that they have missed the question with another attempt to try without any penalty to the students' performance record, on the 3^{rd} attempt with a wrong answer the student is show (FIG. 14-1040) the correct answer and must enter it to continue. This wrong answer does penalize the students' performance record and potentially hurting their current personal level status along with the class or team average level score. It is crucial to have timely and quick feed-back on questions either being wrong or correct so the student can adjust their cognitive approach accordingly, at the conclusion of each game (FIG. 15) a summary screen is displayed 1050 informing the students the game has finished. Sequentially, the students are shown class or team results showing Total 1051 number of questions answered by all students, Average 1052 number of questions answered by each student, Class and or team combined Accuracy Percentage 1053 of all questions answered, Current Average Level 1054 of the class or team.

The teacher or administrator can now either conclude the game play or start a new game by accessing module 421 (FIG. 12-1026) and clicking start game. Sequentially at the point the teacher will be presented a few game options before launching the next game round that initializes a sub module (FIG. 4-405) of the teacher CMS 400; these options are but not limited to game length in second or minute increments; typically 30 seconds to 5 minutes, desired accuracy goals (percentage of class correct answers) for the next game, desired milestones in the form of reaching specific game levels, randomly extending a specific number of players game time by a specific number of seconds or minutes allowing for collaboration or peer coaching during this extended period, configuring the percentage of questions to be selected from a particular game level that will be presented to the students, configuring the amount of review questions that will be pulled from previously mastered class levels; either by percentage or ratio definitions; this feature allows for teacher to instituted continued fluency for the students by presenting problems that the student has mastered previously.

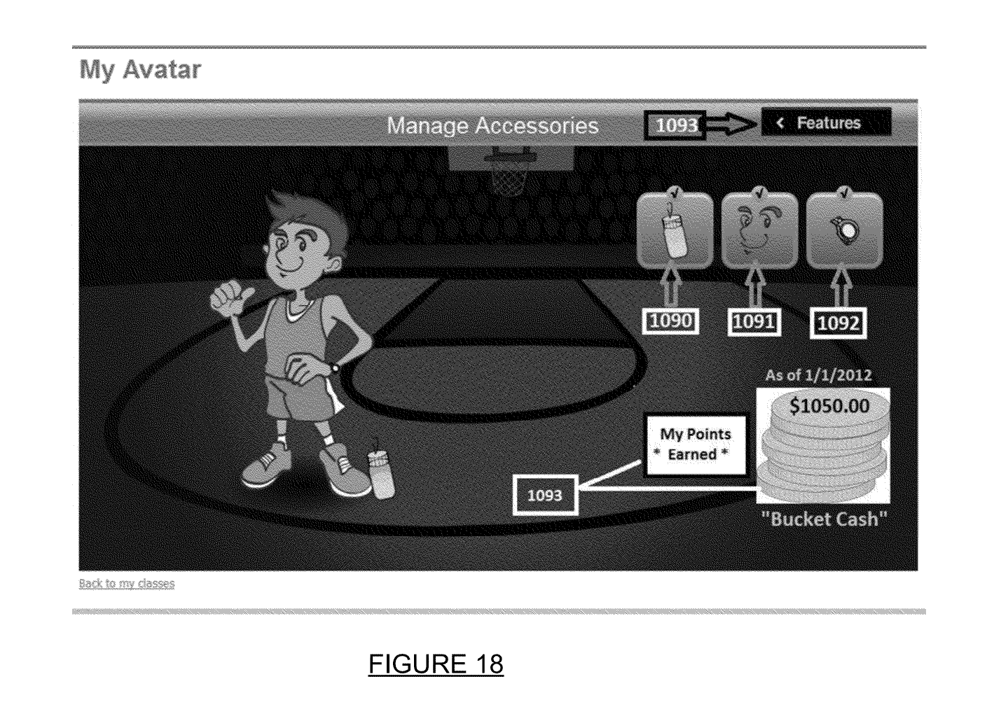

Module 412 is the rewards module (FIG. 18) where student users can manage and view their accumulated “Bucket Cash” value 1093 and avatar accessories awarded 1090, 1091, 1092. By clicking and accessing the features button 1093 a student can make adjustments to their avatar accessories including but not limited to color of accessory item, placement of virtual stickers awarded and collected by the student, and size scaling of the accessory

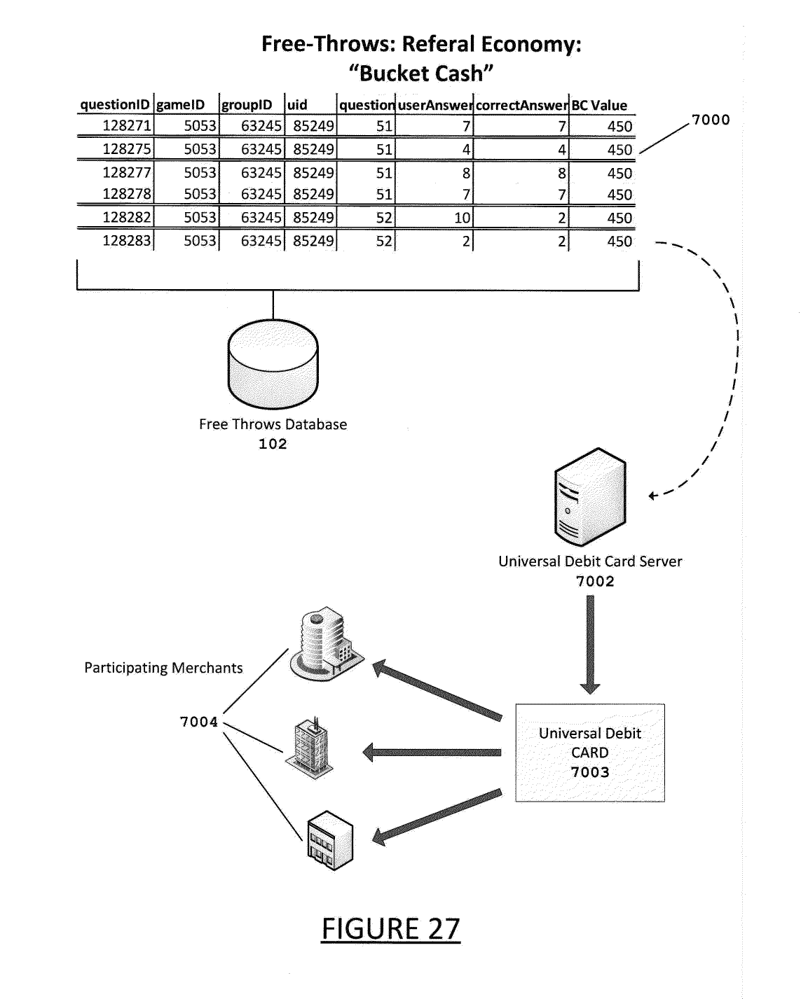

Additionally, “Bucket Cash” point values can be viewed and when initialized students can select goods and services for purchase or discounts based on the exchange value of their “Bucket Cash”. FIG. 27 Illustrates the “Bucket Cash” Referral economy model. The present system database 102 stores every question in the game system with a corresponding “Bucket Cash” value 7000 that is awarded for a correctly answered question for either the individual student or the entire class as a whole. “Bucket Cash” and other rewards like avatar accessories can also be randomly generated to a specified percentage of the student team members or the entire class. Different values can be configured on percentage scale for questions that have been previously mastered and then have been resubmitted to the student for review purposes, in this case the core BC value 7000 is only awarded at full value on the first time the student receives the particular question and answers it correctly. The present system organization would independently subscript to an existing debit card vendor offering a rewards program that can be managed and sponsored solely by the present system. In turn, periodically the present system database 102 would transmit via server 103 to the debit card vendor's server 7002 the data parameters of each student's unique ID, and “Bucket Cash” 7000 point value. Sequentially the debit card vendor would update their database to reflect the new balance on the present system sponsored debit card 7003. Participating merchants 7004 would then accept this card's “Bucket Cash” rewards value on designated products and services for cash or discounts on.

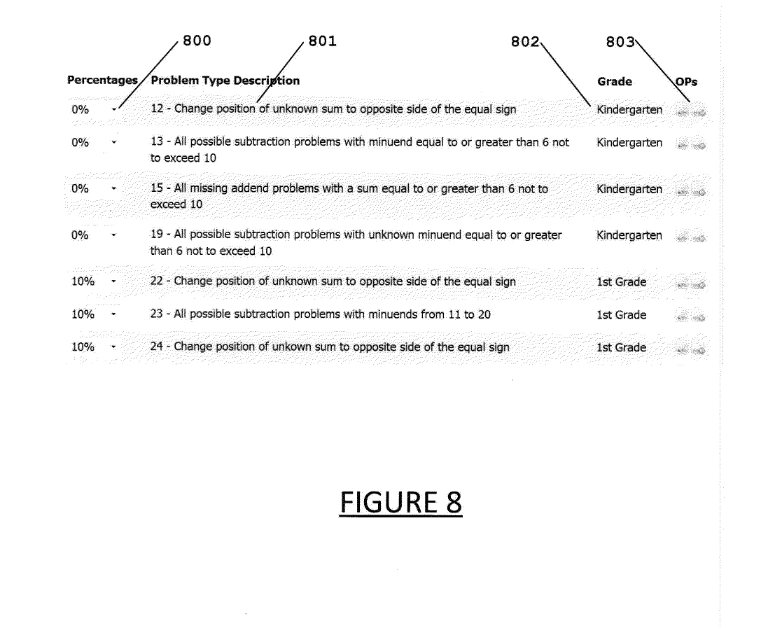

The CMS teacher/administrator module 400 allows teachers and administrators control specific game play parameters, problem type configurations, and reporting analytics access. This core CMS module 400 contains seven sub modules including:
1. Game Play Duration Settings 405—Teachers can adjust game times to a specific time frame in seconds and or minutes, typically 30 seconds to 5 minutes is used for a particular game to resemble game sprints vs. long dawn out durations.
2. Student Current Game Results 406—Teachers can get the same statistics in FIG. 15 depicts for each student's individual performance.
3. Student Reward Configurations 407—Teachers can select from pre-determined rewards in various forms that will be given out to randomly or individually at the conclusion of each game to a specific number of students or the each student base on how the teacher configures the reward strategy. Typically, the default setting for the game is to randomly reward ⅙ of the class with reward incentives. However, in certain higher level classes the ability to reward individuals that complete specific milestones (like reaching certain level of questions FIG. 26) can be constructed.
4. Problem Type Settings 401—Each problem stored in the 102 database for the present system game can be created from scratch or imported from the “Common Core” 100 database and edited, The editable fields are illustrated in FIG. 7 and include Problem Type Description: 700 A base description of the problem type, Target Grade Level: 701—the academic grade level the problem is targeted for, Number of Operand Variables: 702 number of operand variables that the particular equation will include, Allow Regrouping: 703, and Problem Type: 704 the problem type can be a whole number, fraction, or decimal.

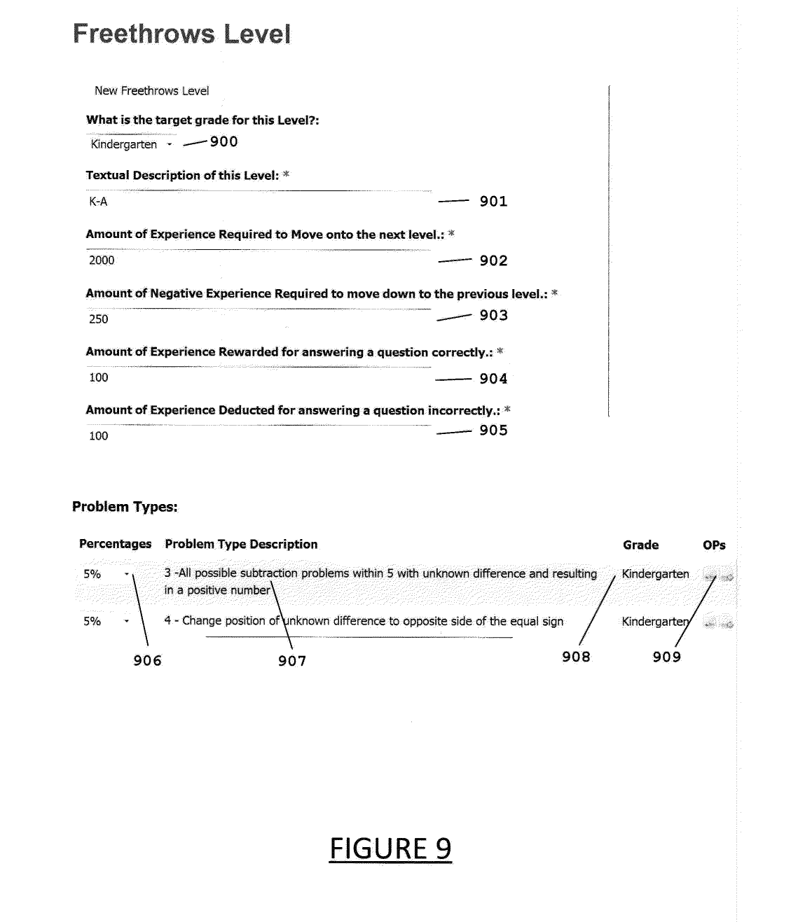

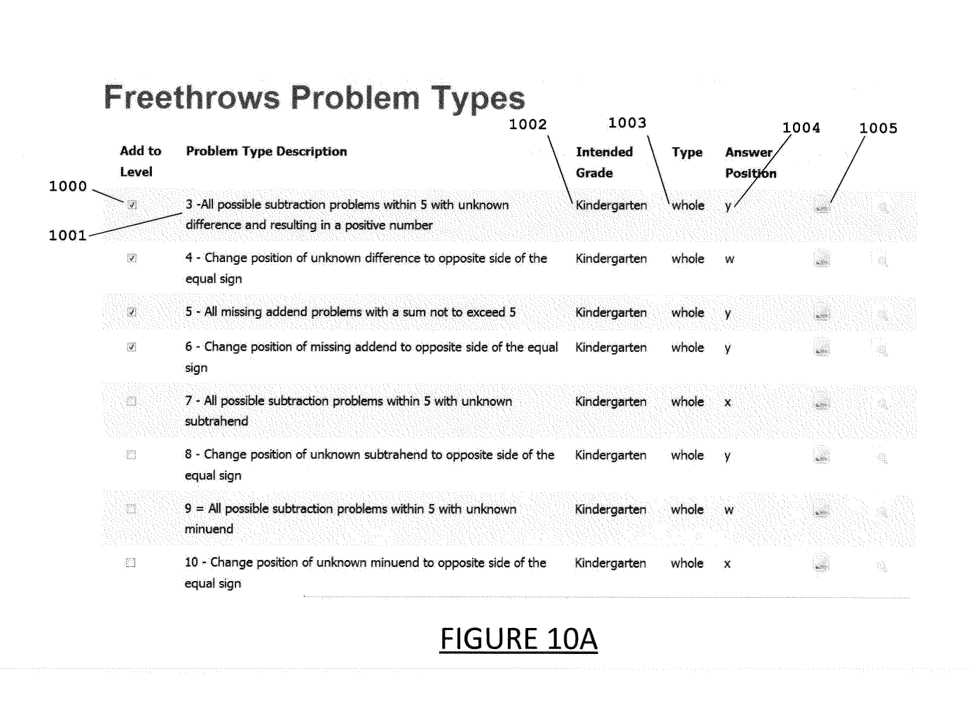

Upon entering the desired choices the teacher user can then either cancel 705 their options or move on to the next layer of configurations FIG. 8. In this layer the teacher user configures the percentage of time 800 the problem will be generated for that particular grade level 802. Furthermore settings can be accessed by selection of the edit or delete buttons 803. If edit button is selected then the teacher user return to FIG. 7 screen.
5. Leveling Up Settings 403—Illustrated in FIG. 9. In this layer the teacher user initially valuates and assigns point levels to grade levels by configuring the following fields:
   Target Grade for this level: 900 The intended grade level the problem is assigned to
   Textual description of this level: 901
   Amount of experience points required to move onto the next level: 902 Points—The accumulative points needed to be earned by a student user to reach the next level above the current one here selected.
   Amount of negative experience points required to move down a level: 903—The accumulative amount of points negative points earned by answering questions incorrectly with the sum of those questions' negative value 905 equally or greater than this amount
   Amount of experience points rewarded for answering question correctly: 904—Positive experience points earned for answering a question correctly at this level
   Amount of experience points deducted for answering a question incorrectly: 905—Negative experience points earned for incorrectly answering a question flagged at this level.

All the problems available to that grade level selected in field 900 will be displayed at the bottom of the screen so the teacher user can view and edit 909:

1. Percentages 906 of a particular problem being generated

2. Problem description 907

3. Grade level 908 the problem is currently assigned to

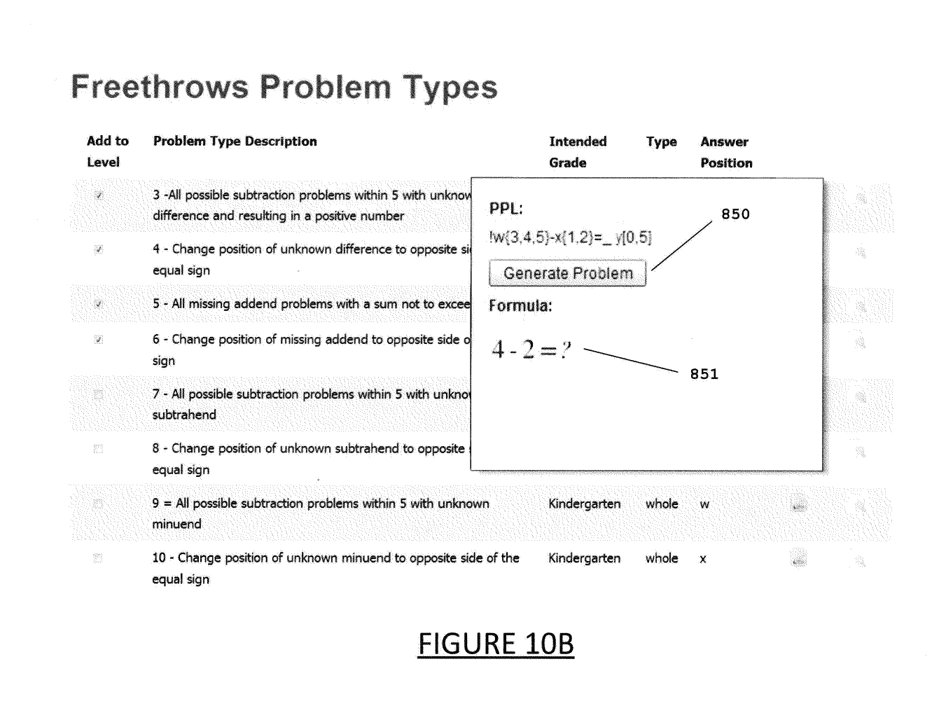

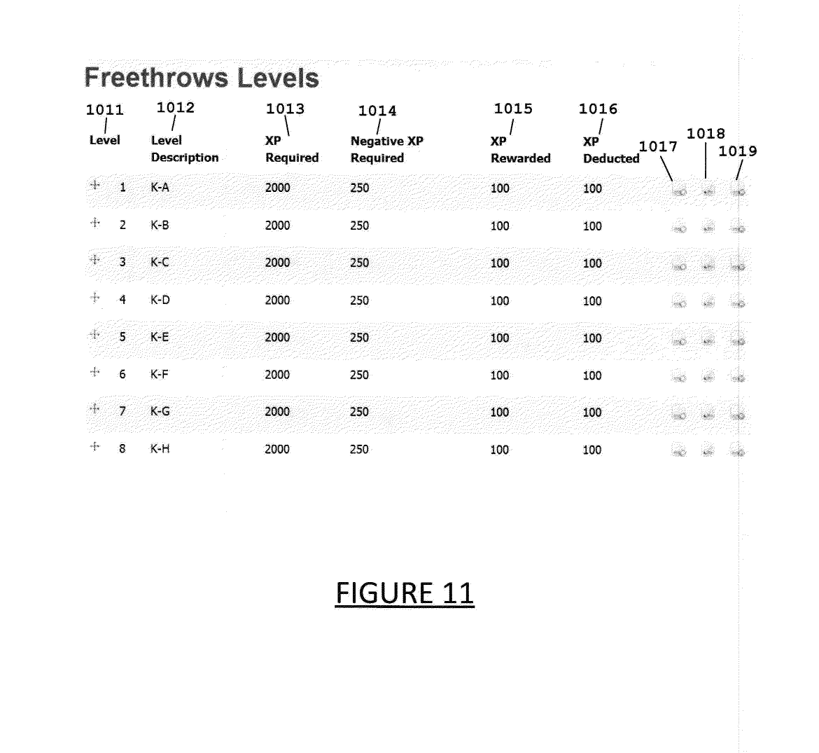

A summary interface for levels created is illustrated in FIG. 11. In this layer the teacher can view all the current experience point levels and their respective grade associations. The user can view all current levels here and add 1017 new ones, edit 1018 current levels, or delete 1019 current levels. The summary interface here displays all the following fields concerning each level:
Level 1011 numerical number value
Level Description 1012
Positive Experience Points Required 1013 to move up to the next level
Negative Experience Points Required 1014 to move down to the next previous level
Positive Experience Points Earned/Rewarded 1015 for answering the particular question correctly
Negative Experience Points Earned/Rewarded for incorrectly answering the specific question
6. Grade Level Settings 402—Illustrated in FIG. 10A, This is the interface where problems can be assigned to specific levels and corresponding grades. By checking the Add to Level Check Box 1000 a teacher user can assign that problem to the specific grade level 1002 displayed. The problem description 1001, problem type 1003, answer position 1004, along with the intended grade level 1002 are all displayed for the user to make informed decisions. If the teacher user wished to edit the problem or a particular problem field then the edit button 1005 is selected and then FIG. 10B options become available where the teacher user can text a specific problem by generating 850 an real-time example that will be displayed 851 for the user to evaluate that problem type would generate sample problems on the students game screen FIG. 13-1034.
7. Student Analytics 408—Teachers will have access to a variety of reports that detail both individual student and class performance statistics. These analytical reports include:

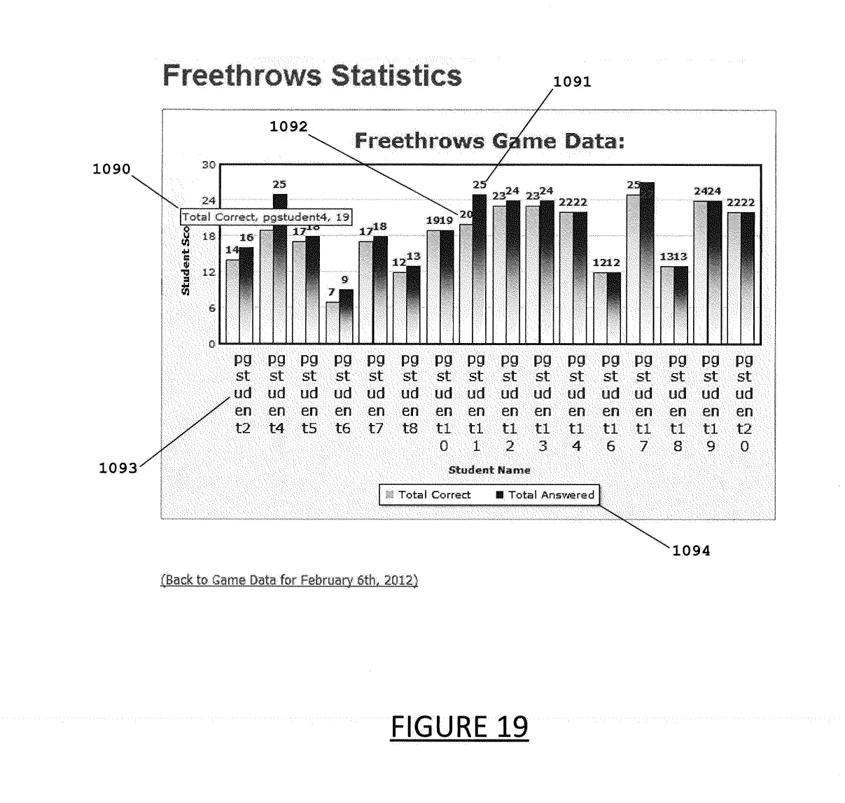

1. Game Data Accumulative Individual Student Summary—Illustrated in FIG. 19 where each student 1093 is graphed to show both the number of questions the answered correctly 1092 and the total questions answered 1091. Additional graph legend 1094 guides the report viewer on how to interpret the values, an additional mouse over function allows detail information to pop up 1090 when the region is selected by the input mouse 209

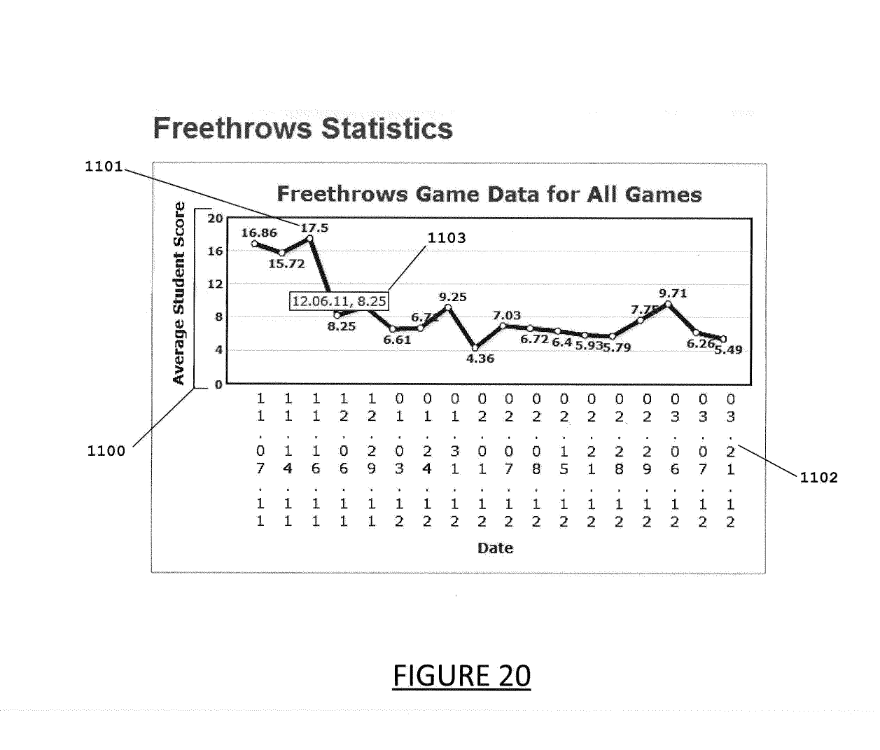

2. Game Date for All Games Summary—FIG. 20 where the average score 1100 basis value is on the Y axis and the particular day of the year 1102 is represented on the X axis. Specific points on the line graph 1101 depict the average score for the day for all games played for a specific class or team. Additionally, detailed information can be accessed 1103 by activating the mouse function using input mouse 209

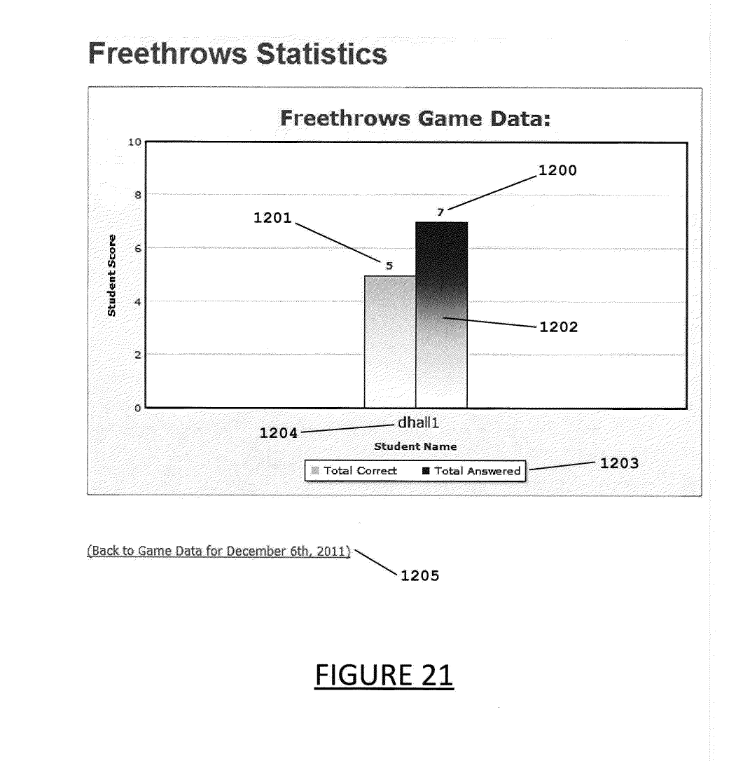

3. Individual Student Single Game Data—FIG. 21 where the students name is displayed 1204 on the X axis. The total correct answers 1201 for that games is displayed along with the total answered questions 1200 presented to the student during the game. A legend 1203 is presented to the viewer to determine which bar graph 1202 represents what value.

In this embodiment of the present invention, each of the four CMS 400 sub modules deal directly with settings and reporting that only teachers and administrators have access to.

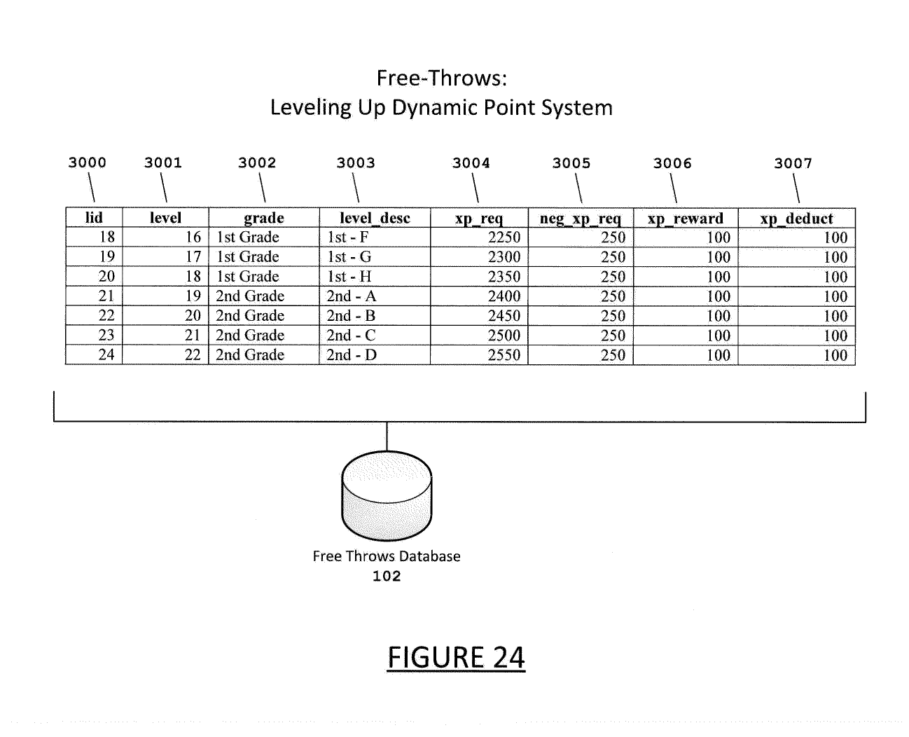

Illustrated in FIG. 24, is an example how the present system leveling point system is stored in the present system Database (FIG. 1-102) with regards to the level table architecture. The following data fields are captured: Level ID 3000—a unique ID indicator value, Level 3001—the actual numerical in game displayed level value, Grade 3002—the associated grade level to the point level value, Level Description 3003, Accumulative Positive Experience Points Required 3004 to reach the next level, Accumulative Negative Experience Points Required 3005 to move down a level, Positive Experience Points rewarded 3006 for this particular question being answered correctly, and Negative Experience Points awarded 3007 for this particular question being incorrectly answered.

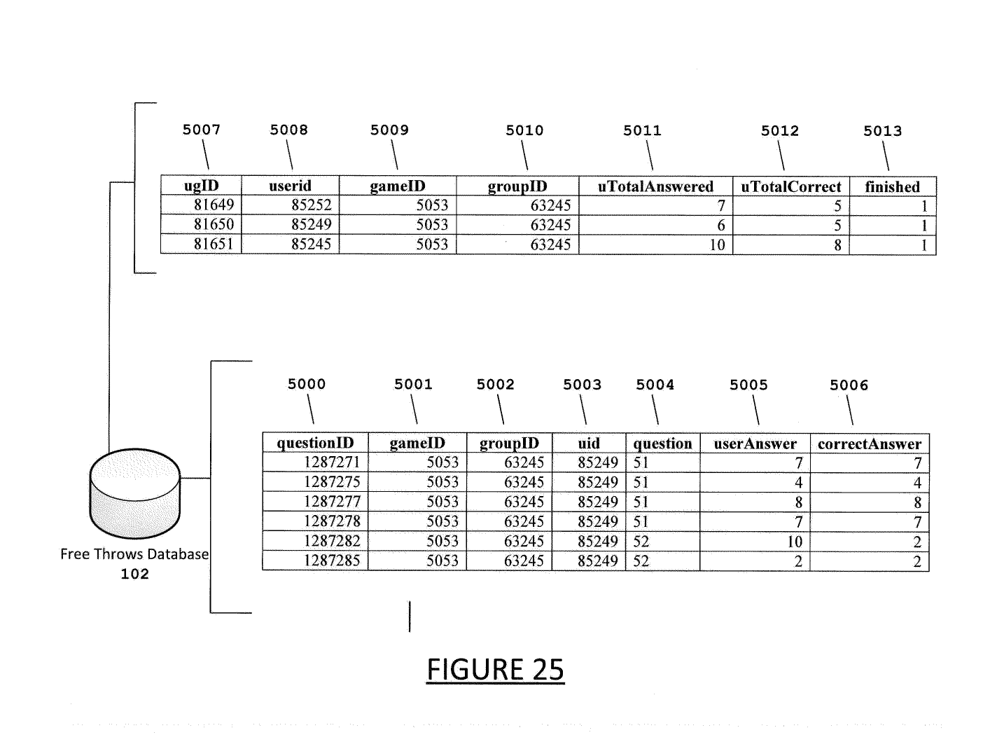

Additionally, illustrated in FIG. 25, is an example how the present system leveling point system is stored in the present system Database (FIG. 1-102) at the student/user level table architecture. The following fields are captured in the database table structure: Specific game group ID 5007 that student was assigned to while participating in a specific game, this identifies what class or team the student was on, The unique ID for the student 5008, The Specific Game ID 5009 the student participated in, The class or team ID 5010 the student belongs to, Total number of question attempted to be answered 5011 by the student for a give game session, Total correctly answered questions 5012 a student obtained from a specific game played, and At positive 1 or null value if the student finished 5013 the particular game.

Furthermore, illustrated in FIG. 25, is an example how the present system leveling point system is stored in the present system Database (FIG. 1-102) at the student/user level question and answer detail table architecture. The following fields are captured in the database table structure: The unique question ID 5000 that the student has been presented in the game interface FIG. 13-1035, The unique game ID 5001 the problem was generated in, The unique group ID 5002 that the student was a member of during the game play, The unique user ID 5003 the student is assigned that identifies the student through the database 102, The unique question ID 5004 that each problem throughout the database 102 is assigned, The user answer value 5005 that is stored from the input screen FIG. 13-1035 the student entered, this is the true value entered regardless of being the correct or incorrect answer, and The actual correct answer value 5006 that is used throughout the 102 database, this is the answer value used to determine if the student gets the problem correct and therefore receives positive or negative experience points base on the comparisons between 5005 and 5006 fields.

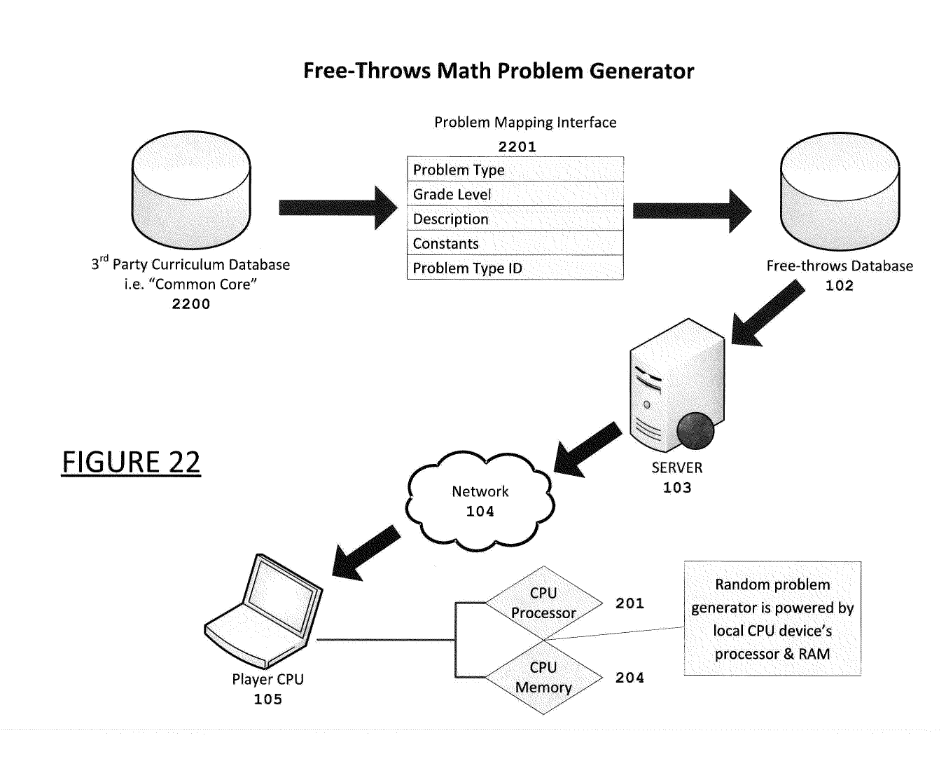

To further explain how the system generates real time problems on the students interface computer the illustration in FIG. 22, outlines the process flow of how the problem generator system access the Database (FIG. 1-102) and delivers the problems to the students FIG. 1-105 computer devices.

Initially a 3^{rd} party database 2200 offering curriculum standards and or problems can be utilized through a problem mapping interface 2201 that will interpret the data and format it into the present system 102 database. In turn the present system server 103 accesses the database elements required to disseminate the metadata information over the internet 104 in accordance to FIG. 1 explanation. At the point the individual players/students computer in accordance with FIG. 1 explanation, will receive the instructions and parameters to generate the problems each game presents. Each student/player device will utilize the on board CPU 201 and ROM 204 in accordance with FIG. 1 explanation, whereas the local device 105 will generate the random problem based on the problem type settings from module 401

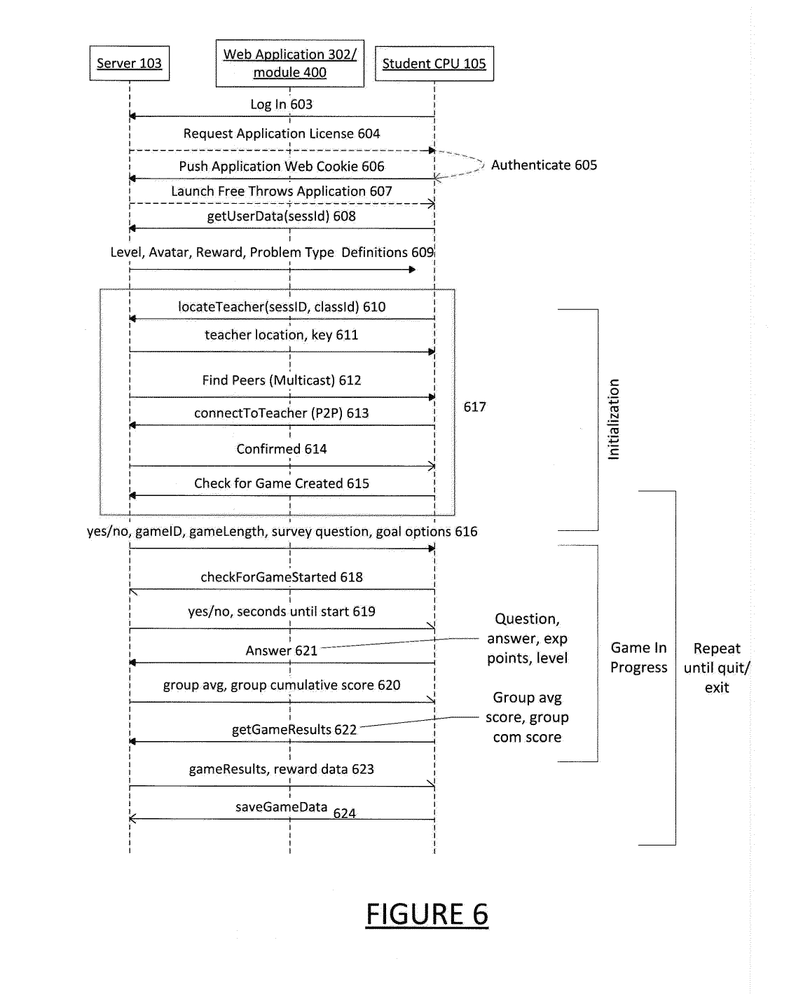

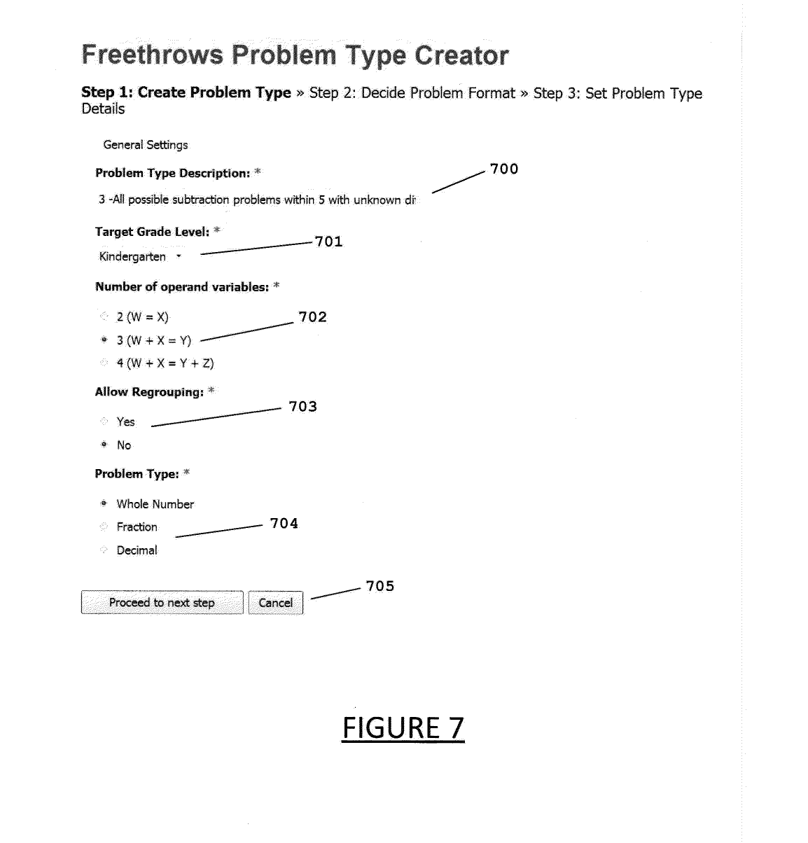

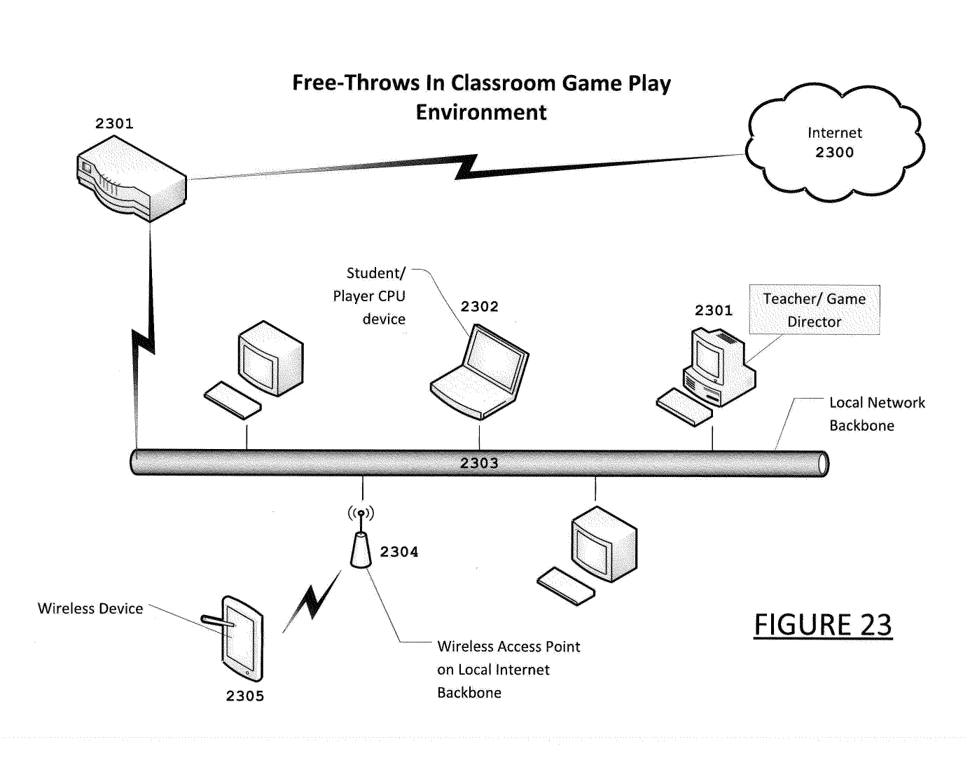

Additionally supplied Illustrations include FIG. 5, FIG. 6 and FIG. 23. FIG. 5 is a basic sequence diagram of the process flow between the 103 server, and the 105 access computer being utilized by a teacher or administrator to access the CMS 400 module via the 302 server application/web portal. Important to note here that the passing of a web cookie for validation or license credentialing is utilized or proposed. FIG. 6 is a basic sequence diagram of the process flow between the 105 student user computer, the 103 server, and the 302 server application/web portal. Important to note here that the passing of a web cookie for validation or license credentialing is utilized or propose. FIG. 23 is a basic diagram of how the present system program could be constructed in a typical classroom, important to note the wireless access points and how the teacher could use any workstation or CPU device with internet access to utilize the CMS 400 module.

As has been noted above, embodiments of the present invention may be implemented with the aid of computer-implemented processes or methods (a.k.a. programs or routines). These processes may be rendered in any computer-readable language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

What is claimed is:

1. A system for providing an educational game, comprising:
a processor;
a memory in communication with the processor; and
a plurality of modules stored in memory and executed by the processor to provide a series of problems via a game to each of a plurality of students, the problems provided through an interface provided by a client device for each student, provide a visual indicator for each student upon completion of a problem of the series of problems, and track a total score for the plurality of students as they play the game.

2. The system of claim 1, wherein the modules are executable by the processor to receive a request to configure problem types with level parameters used to determine milestones of success.

3. The system of claim 1, wherein the modules are executable by the processor to receive request to configure game time settings and feedback duration intervals.

4. The system of claim 1, wherein the modules are executable by the processor to receive input to configure desired accuracy goals.

5. The system of claim 1, wherein the modules are executable by the processor to receive input to configure desired milestones.

6. The system of claim 1, wherein the modules are executable by the processor to receive input to configure a percentage of questions selected from a particular game level.

7. The system of claim 1, wherein the modules are executable by the processor to receive input to configure amount of review questions pulled from previously mastered class levels.

8. The system of claim 1, wherein the modules are executable by the processor to receive input to configure the complexity of problem types.

9. The system of claim 1, wherein the modules are executable by the processor to receive input to configure the difficulty of problems.

10. The system of claim 1, wherein the modules are executable by the processor to receive input to configure goals for a group of students and individual students.

11. The system of claim 1, wherein the modules are executable by the processor to receive input to configure competition challenges between two groups of students.

12. The system of claim 1, wherein the modules are executable by the processor to provide cumulative and single game performance data for an individual student

13. The system of claim 1, wherein the modules are executable by the processor to provide cumulative game performance data for a group of students.

14. The system of claim 1, wherein the modules are executable by the processor to provide student success data based on problem type and problem level.

15. The system of claim 1, wherein the modules are executable by the processor to display, in an interface for each student, the total number of questions answered correctly, average number of questions answered correctly, and a combined accuracy percentage at the end of a game.

16. The system of claim 1, wherein the modules are executable by the processor to advance a student to a next level through graduated scaling.

17. The system of claim 16, wherein the student is not informed through the game that the student has advanced to a next level.

18. The system of claim 1, wherein the modules are executable by the processor to determine the group of students has achieved a group score goal and randomly select a portion of the group of students to receive an award.

19. The system of claim 18, wherein the award is virtual award.

20. The system of claim 19, wherein the award is an award for an avatar.

21. The system of claim 19, wherein the award includes virtual cash.

22. The system of claim 19, wherein the award is a debit card

23. The system of claim 1, wherein the modules are executable by the processor to receive a selection by an administrator of an individual student to receive a reward.

24. The system of claim 1, wherein the modules are executable by the processor to determine whether to play a new game based on input received from the plurality of students.

25. The system of claim 1, wherein the modules are executable by the processor to allow a student to customize an avatar associated with the student.

26. The system of claim 1, wherein the modules are executable to provide an interface to the student, the interface including the student avatar and a problem for the student to solve.

27. The system of claim 26, the interface providing the amount of time left in the current game.

28. The system of claim 26, wherein the interface provides the average score and average accuracy for the group of students.

29. A method for providing an educational game to a plurality of students, the method comprising:
providing a series of problems via a game to each of a plurality of students, the problems provided through an interface provided by a client device for each student,
providing a visual indicator for each student upon completion of a problem of the series of problems; and
tracking a total score for the plurality of students as they play the game.

30. The method of claim 29, further comprising receiving a request to configure problem types with level parameters used to determine milestones of success.

31. The method of claim 29, further comprising receiving request to configure game time settings and feedback duration intervals.

32. The method of claim 29, further comprising receiving input to configure desired accuracy goals.

33. The method of claim 29, further comprising receiving input to configure desired milestones.

34. The method of claim 29, further comprising receiving input to configure a percentage of questions selected from a particular game level.

35. The method of claim 29, further comprising receiving input to configure amount of review questions pulled from previously mastered class levels.

36. The method of claim 29, further comprising receiving input to configure the complexity of problem types.

37. The method of claim 29, further comprising receiving input to configure the difficulty of problems.

38. The method of claim 29, further comprising receiving input to configure goals for a group of students and individual students.

39. The method of claim 29, further comprising receiving input to configure competition challenges between two groups of students.

40. The method of claim 29, further comprising providing cumulative and single game performance data for an individual student

41. The method of claim 29, further comprising providing cumulative game performance data for a group of students.

42. The method of claim 29, further providing student success data based on problem type and problem level.

43. The method of claim 29, further comprising, in an interface for each student, displaying the total number of questions answered correctly, average number of questions answered correctly, and a combined accuracy percentage at the end of a game.

44. The method of claim 29, further comprising advancing a student to a next level through graduated scaling.

45. The method of claim 44, wherein the student is not informed through the game that the student has advanced to a next level.

46. The method of claim 29, further comprising:
determining the group of students has achieved a group score goal; and
randomly selecting a portion of the group of students to receive an award.

47. The method of claim 29, wherein the award is virtual award.

48. The method of claim 29, wherein the award is one of an avatar modification, virtual cash, and a debit card.

49. The method of claim 29, further comprising receiving a selection by an administrator of an individual student to receive a reward.

50. The method of claim 29, further comprising wherein the plurality of students determine whether to collectively continue.

51. The method of claim 29, wherein the problem is a math problem.

52. The method of claim 29, wherein the indicator is virtual sports achievement.

53. The method of claim 29, further comprising establishing a record for each student participating in the game.

54. The method of claim 29, further comprising allowing a student to customize an avatar associated with the student.

55. The method of claim 29, further comprising providing an interface to the student, the interface including the student avatar and a problem for the student to solve.

56. The method of claim 55, the interface providing the amount of time left in the current game.

57. The method of claim 55, the interface providing the average score and average accuracy for the group of students.

58. The method of claim 29, further comprising input from an administrator to control game parameters.

59. The method of claim 58, wherein the game parameters includes one of a game play duration, student reward configuration, problem type settings, leveling up settings, and grade level settings.
